(19) United States
(12) Patent Application Publication
(10) Pub. No.: US 2016/0147188 A1
(43) Pub. Date: May 26, 2016

(54) SHEET FEEDING CASSETTE AND IMAGE FORMING APPARATUS INCLUDING THIS

(71) Applicant: KYOCERA Document Solutions Inc., Osaka (JP)

(72) Inventor: Kiyonori YAMAMOTO, Osaka-shi (JP)

(73) Assignee: KYOCERA Document Solutions Inc., Osaka (JP)

(21) Appl. No.: 14/942,254

(22) Filed: Nov. 16, 2015

(30) Foreign Application Priority Data
Nov. 21, 2014 (JP) 2014-236678

(51) Int. Cl. G03G 15/00; B65H 1/26

(52) U.S. Cl. CPC G03G 15/6511; B65H 1/266

(57) ABSTRACT

A sheet feeding cassette includes a cassette main body and a cassette cover. The cassette main body is attachably/detachably provided in a casing, and configured to store sheets in a loaded state. The cassette cover configured to close at least a part of a top face aperture formed in the cassette main body. Either one of the cassette main body and the cassette cover includes a cursor displaced along an attachment direction of the cassette main body and arranging the sheets housed in the cassette main body. Another one of the cassette main body and the cassette cover includes at least one restraining part which engages with the cursor in a case where the top face aperture is closed by the cassette cover.

### INCORPORATION BY REFERENCE

This application is based on and claims the benefit of priority from Japanese Patent application No. 2014-236678 filed on Nov. 21, 2014, the entire contents of which are incorporated herein by reference.

### BACKGROUND

The present disclosure relates to a sheet feeding cassette preferably applied in a copying machine or a printer or the like and an image forming apparatus including the cartridge.

A sheet feeding cassette to store sheets in a loaded state is known.

For example, there is a sheet feeding cassette constituting a first cartridge and a second cartridge in a nesting manner, and attachably/detachably provided at an apparatus main body. The first cartridge is configured to expand/contract (slide) with respect to the second cartridge along an attachment direction of the sheet feeding cassette. The sheet feeding cassette has: a pair of left and right width restraining guide to move in a right-left direction orthogonal to the attachment direction and abut against both of the left and the right of a sheet; and a length position restraining guide to move along the attachment direction and abuts against a rear end of the sheet.

In the meanwhile, the sheet feeding cassette described above is pushed into the apparatus main body through an aperture formed in the apparatus main body. In general, if the sheet feeding cassette is positioned in the apparatus main body, movement in the attachment direction is restrained (stopped). For example, in a case where a sheet feeding cassette housing a large number of sheets (a bundle of sheets) has been attached to the apparatus main body with an extreme force, the bundle of sheets in the sheet feeding cassette is about to move in the attachment direction by an inertial force. In this case, the length position restraining guide cannot support the bundle of sheets acted by the inertial force, there has been an apprehension that the length position restraining guide is displaced in the attachment direction. Thus, the sheet feeding cassette described above has entailed a problem that normal sheet supply (sheet feeding) cannot be carried out due to the displacement of the bundle of sheets or the like.

In order to countervail the inertial force acting on the bundle of sheets, it is considered to provide a locking structure which restrains movement (displacement) of the length position restraining guide as well. In this case, in order to move the length position restraining guide at the time of setting the bundle of sheets, unlocking must be carried out. Thus, there has been a problem that usability (operability) by a user lowers.

Further, for example, in a case where an extraordinary large inertial force has acted on the bundle of sheets, there has been an apprehension that the length position restraining guide is damaged. In order to improve impact resistance capability of the length position restraining guide, there has been a case in which upsizing of the length position restraining guide or material change or the like is required. Also, there has been a case in which a damper for absorbing an impact at the time of attachment is provided at the apparatus main body or the sheet feeding cassette. Thus, the sheet feeding cassette mentioned above has required much cumbersomeness and costs for taking countermeasures against the damage to the length position restraining guide so far.

### SUMMARY

According to one aspect of the present disclosure, a sheet feeding cassette includes a cassette main body and a cassette cover. The cassette main body is attachably/detachably provided in a casing, and configured to store sheets in a loaded state. The cassette cover configured to close at least a part of a top face aperture formed in the cassette main body. Either one of the cassette main body and the cassette cover includes a cursor displaced along an attachment direction of the cassette main body and arranging the sheets housed in the cassette main body. Another one of the cassette main body and the cassette cover includes at least one restraining part which engages with the cursor in a case where the top face aperture is closed by the cassette cover.

According to one aspect of the present disclosure, an image forming apparatus includes a sheet feeding cassette provided at an apparatus main body. The sheet feeding cassette includes a cassette main body and a cassette cover. The cassette main body is attachably/detachably provided in a casing, and configured to store sheets in a loaded state. The cassette cover configured to close at least a part of a top face aperture formed in the cassette main body. Either one of the cassette main body and the cassette cover includes a cursor displaced along an attachment direction of the cassette main body and arranging the sheets housed in the cassette main body. Another one of the cassette main body and the cassette cover includes at least one restraining part which engages with the cursor in a case where the top face aperture is closed by the cassette cover.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing a printer of one embodiment of the present disclosure.

FIG. 2 is a sectional view schematically showing an inner structure of the printer according to one embodiment of the present disclosure.

FIG. 3 is a perspective view showing an inside of a sheet feeding cassette according to one embodiment of the present disclosure.

FIG. 4 is a perspective view showing the sheet feeding cassette according to one embodiment of the present disclosure.

FIG. 5 is a perspective view showing a rear end cursor of the sheet feeding cassette according to one embodiment of the present disclosure.

FIG. 6 is a perspective view showing a cassette cover of the sheet feeding cassette according to one embodiment of the present disclosure.

FIG. 7 is a sectional view schematically showing a rear part of the sheet feeding cassette according to one embodiment of the present disclosure, showing the cassette cover turning to an open position.

FIG. 8 is a sectional view schematically showing a rear part of the sheet feeding cassette according to one embodiment of the present disclosure, showing the cassette cover turning to a closed position.

FIG. 9A is a sectional view schematically showing a rear part of a sheet feeding cassette according to a modified example of one embodiment of the present disclosure; and

FIG. 9B is a sectional view schematically showing a rear part of a sheet feeding cassette according to another modified example of one embodiment of the present disclosure.

### DETAILED DESCRIPTION

In the following, a preferable embodiment of the present disclosure will be described with reference to the appended drawings.

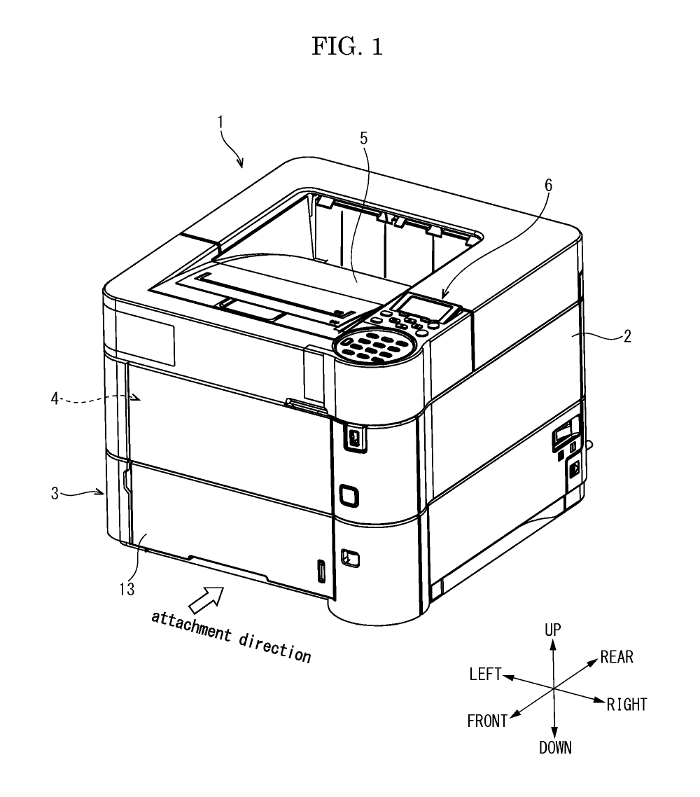

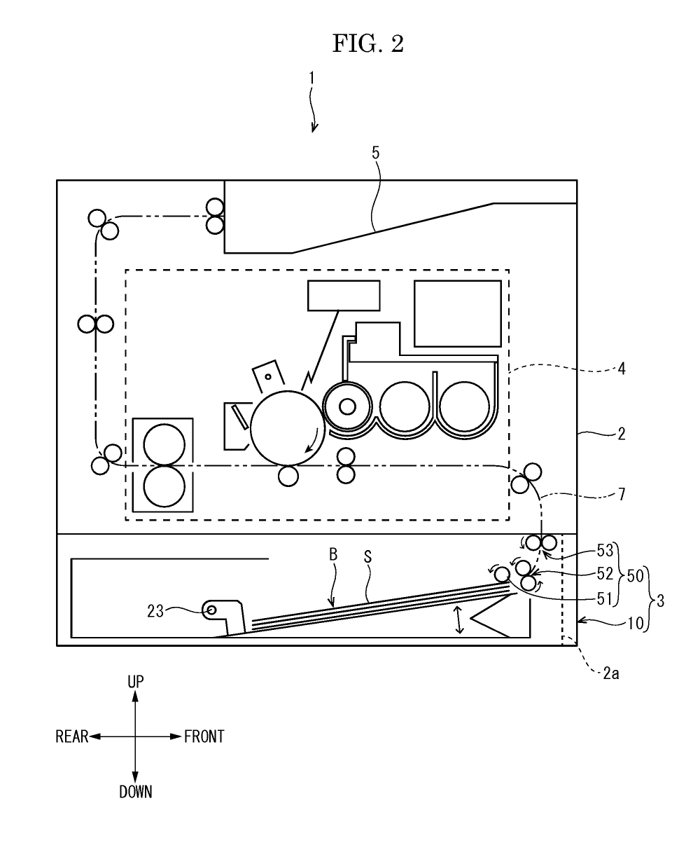

With reference to FIG. 1 and FIG. 2, an entire construction of a printer 1 as an image forming apparatus will be described. FIG. 1 is a perspective view showing the printer 1. FIG. 2 is a sectional view schematically showing an inner structure of the printer 1. It is noted that directions are indicated appropriately in each drawing in the following description.

The printer 1 is configured to include an apparatus main body 2, a sheet feeding device 3, an image forming unit 4, and an ejecting tray 5. The apparatus main body 2 as a casing is formed in a substantially rectangular box shape as a whole. The sheet feeding device 3 is provided at a lower part of the apparatus main body 2. The image forming unit 4 is internally provided at an upper part of the apparatus main body 2. The ejecting tray 5 is provided on a top face of the apparatus main body 2.

A front right part of the apparatus main body 2 is formed in a substantially cylindrical shape. On a top face of the front right part of the apparatus main body 2, an operating unit 6 (liquid crystal display unit or numeric keys or the like) which is operated by a user who utilizes the printer 1 is provided.

The sheet feeding device 3 feeds out a sheet S housed inside thereof toward a conveying path 7 in the apparatus main body 2. Incidentally, the sheet feeding device 3 will be described in detail later. Incidentally, the sheet S includes a sheet-shaped recording medium such as a plastic film or an OHP (Overhead Projector) sheet without being limited to a sheet of paper.

The image forming unit 4 carries out image forming in a publicly known electrophotographic as to the sheet that is fed out from the sheet feeding device 3 to the conveying path 7. The sheet S for which image forming has been carried out is further conveyed to a downstream side of the conveying path 7, and is ejected from the inside of the apparatus main body 4 to the sheet ejecting tray 5.

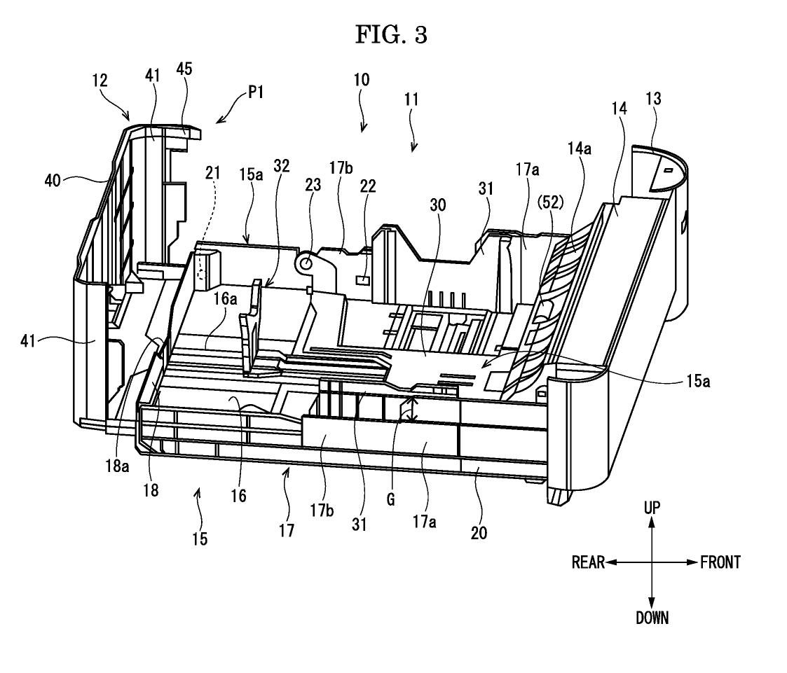

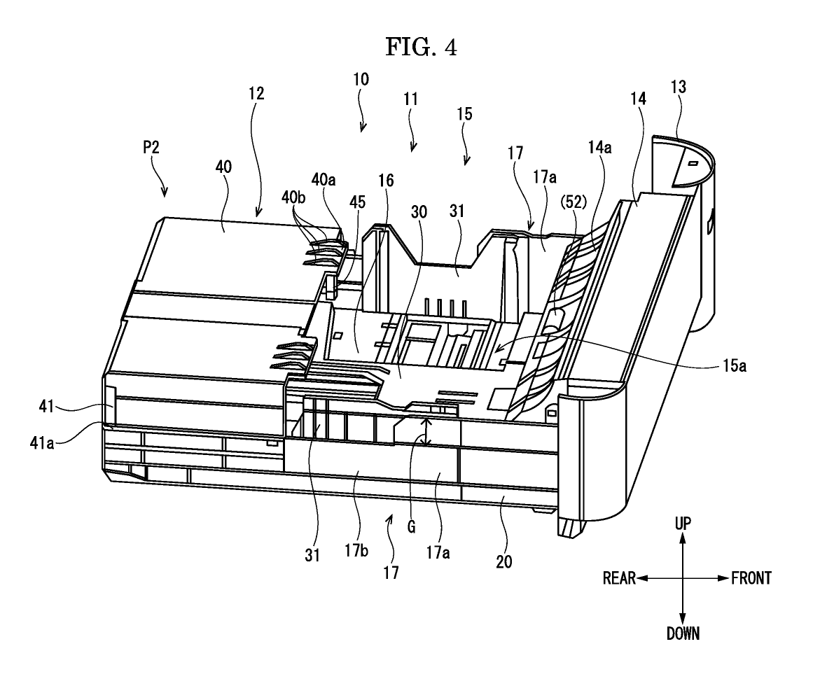

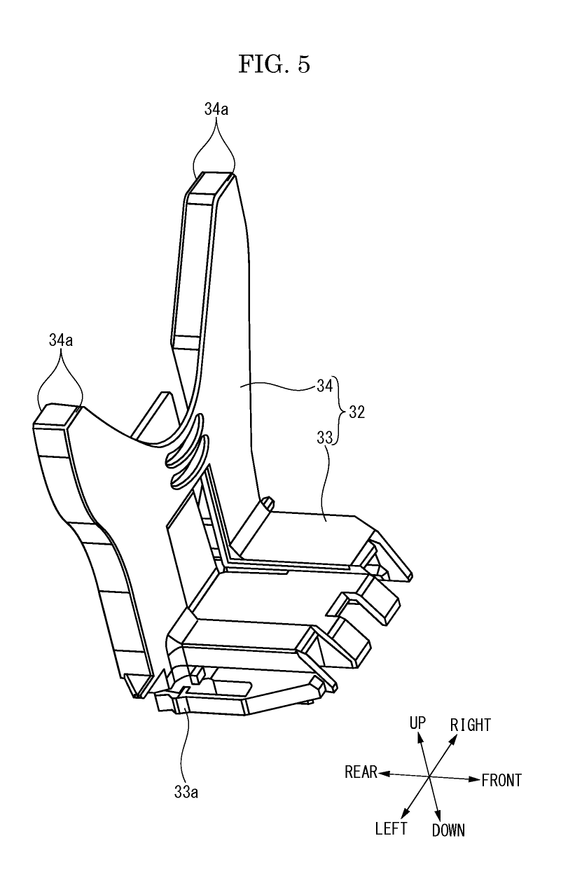

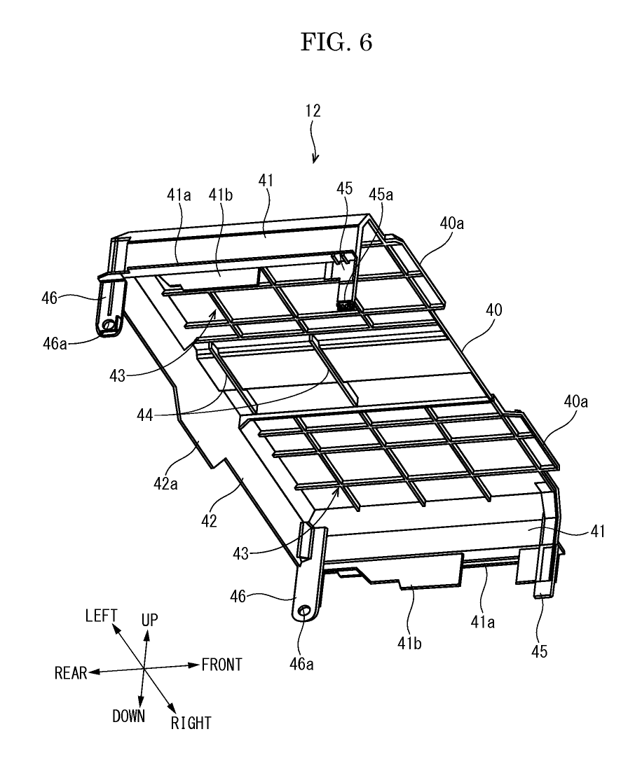

Next, the sheet feeding device 3 will be described in detail below with reference to FIGS. 2 through 6. FIG. 3 is a perspective view showing an inside of a sheet feeding cassette 10. FIG. 4 is a perspective view showing the sheet feeding cassette 10. FIG. 5 is a perspective view showing a rear end cursor 32 of the sheet feeding cassette 10. FIG. 6 is a perspective view showing a cassette cover 12 of the sheet feeding cassette 10.

As shown in FIG. 2, the sheet feeding device 3 is configured to include a sheet feeding cassette 10 and a sheet feeder 50. The sheet feeding cassette 10 houses a sheet bundle B stacked inside thereof. The sheet conveying part 50 feeds out a sheet S in the sheet feeding cassette 10 toward the conveying path 7.

As shown in FIG. 3 and FIG. 4, the sheet feeding cassette 10 is configured to include a cassette main body 11 and a cassette cover 12. The cassette main body 11 is attachably/detachably provided at the apparatus main body 2. The cassette cover 12 is provided to be able to open or close a part of a top face aperture 15a which is formed in the cassette main body 11.

The cassette main body 11 is formed in a substantially rectangular box shape in order to store sheets S in a loaded state. The cassette main body 11 has: a design face 13; a mechanical retaining part 14; and a housing 15.

On the right side of the design face 13 is formed in a substantially semi-cylindrical shape, like the apparatus main body 2. The design face 13 is supported by the mechanical retaining part 14 so as to constitute a front face of the cassette main body 11. When the cassette main body 11 is attached to the apparatus main body 2, the design face 13 forms a substantially same face as the front face of the apparatus main body 2 (refer to FIG. 1).

The mechanical retaining part 14 is formed in a substantial rectangular parallelepiped extending in a right-left direction. At atop face rear part of the mechanical retaining part 14, an inclined plane 14a of a downward slope is formed.

The housing 15 is extended from a rear face of the mechanical retaining part 14 toward a rear side. The housing 15 is integrally formed to include a bottom plate 16, a pair of left and right side walls 17, and a rear wall 18. The bottom plate 16 is formed in a substantially rectangular plate shape in a planar view. The pair of left and right side walls 17 are erected at both of the left and right ends of the bottom plate 16, and the rear wall 18 is erected at a rear end of the bottom plate 16. That is, the housing 15 is formed in a substantially tray shape which opens a top face (having a top face aperture 15a).

At outside face lower sides of the pair of left and right side walls 17, slide gaps 20 are respectively extended in a front-rear direction. The pair of left and right slide gaps 20 respectively engages with slide rails (not shown) which are provided on inside faces of both of the left and right of the apparatus main body 2. Thereby, the sheet feeding cassette 10 is inserted into the apparatus main body 2 through an aperture 2a (refer to FIG. 2) which is formed at the front face lower part of the apparatus main body 2, and is slidably supported by the slide rail.

The pair of left and right side walls 17 each have a high wall 17a and a low wall 17b. Each of the high walls 17a is formed in a substantially rectangular plate shape in aside view, and is extended from a side face of the mechanical retaining part 17a to a rear side. Each of the low walls 17b is formed in a substantially rectangular plate shape which is shorter than the high wall 17a in a side view. Each of the low walls 17b is extended from a lower part of the high wall 17a toward a rear side. That is, an upper end face of each of the low walls 17b is formed at a position (refer to a step difference G) which is lower than by one step than the upper end face of the high wall 17a. On the rear interior faces of the pair of left and right low walls 17b, cover turning shafts 21 are respectively protruded. On intermediate interior faces in the front-rear direction of the pair of left and right low walls 17b, engaging depressions 22 are respectively recessed.

The rear wall 18 is formed in a substantially rectangular plate shape in a rear view. At a substantial center in the right-left direction of the rear wall 18, a depression-shaped part 18a is cut downward from an upper end (refer to FIG. 3).

Inside of the housing 15 (on the bottom plate 16), a lift plate 30, a pair of left and right width restraining cursors 31, and a rear end cursor 32 are provided.

The lift plate 30 is placed at a center in the right-left direction on a front side of the bottom plate 16. The lift plate 30 is formed in a substantial H-shape to branch both of the front and rear sides into two ways in a planar view. A rear part of the lift plate 30 is supported by a plate turning shaft 23 which is formed at a respective one of the pair of left and right side walls 17. Incidentally, the each of plate turning shaft 23 is arranged at a rear side of the engaging depression 22. Also, between a front part of the lift plate 30 and the bottom plate 16, an elevating mechanism (not shown) is arranged. The lift plate 30 is pushed up by the elevating mechanism, and turns upward about the respective one of the pair of left and right plate turning shafts 23 (refer to FIG. 2). Incidentally, the lift plate 30 turns downward by self-weight.

A pair of left and right width restraining cursors 31 each are formed in a substantially rectangular shape which is elongated in the front-rear direction in a side view. The pair of left and right width restraining cursors 31, on the front side of the bottom plate 16, are provided so as to oppose to each other while the lift plate 30 is sandwiched therebetween. The pair of left and right width restraining cursors 31 each are connected to an interlocking mechanism such as rack and pinion (not shown). The pair of left and right width restraining cursors 31 slide transversely symmetrically due to action of the interlocking mechanism.

As shown in FIG. 3 and FIG. 5, the rear end cursor 32 is composed of a rear end sliding part 33 and a rear end abutment part 34. The rear end cursor 32 is integrally formed of a plastic material, for example, in a substantially L-shape in a side view.

The rear end sliding part 33 (base) slidably engages with a guiding gap 16a extending in the front-rear direction at a substantial center in the right-left direction of the bottom plate 16. Incidentally, the guiding gap 16a is recessed between the vicinity of the rear wall 18 and the vicinity of a branched part of the lift plate 30. On both of the left and right side faces of the guiding gap 16a, a plurality of uneven shapes (not shown) are formed. On both of the left and right side faces of the rear end sliding part 33, protrusions 33a to engage with a depression in an uneven shape of the guiding gap 16a are formed. The protrusion 33a engages with any depression, and a load is thereby applied to a sliding operation of the rear end sliding part 33 with respect to the guiding gap 16a. Thereby, the rear end sliding part 33 can be gently retained at any position of the guiding gap 16a.

As shown in FIG. 5, the rear end abutment part 34 (abutment part) is erected at a rear end of the rear end sliding part 33. The rear end abutment part 34 branches a top part in two ways, and is formed in a substantially Y-shaped plate in a front view. At an upper end of the rear end abutment part 34 that has branched into two ways, a tapered face 34a is formed by chamfering both of the front and rear corners. The rear end abutment part 34 is formed to be slightly elastically deformable in the front-rear direction (conveyance direction). Incidentally, the rear end abutment part 34 is not limited to the substantially Y-shape, and may be formed in a substantially rectangular plate shape, for example.

As shown in FIG. 4, the cassette cover 12 is disposed so as to close a rear side of the top face aperture 15a of the cassette main body 11 (housing 15). That is, the cassette cover 12 is disposed so as to cover a movement range of the rear end cursor 32. Incidentally, hereinafter, a description will be given with reference to a state in which the cassette cover 12 has closed the top face aperture 15a (refer to FIG. 3).

As shown in FIG. 6, the cassette cover 12 is integrally formed to include a top plate 40, a pair of left and right side plates 41, and a rear plate 42. The top plate 40 is formed in a substantially rectangular shape in a planer view. The pair of left and right side plates 41 are formed so as to hang from both of the left and right ends of the top plate 40. The rear plate 42 is formed so as to hang from a rear end of the top plate 40. That is, the house 15 is formed in a substantial tray shape to open a lower face.

At a front end of the top plate 40, a pair of left and right front end pieces 40a extending toward a front side are formed. On a top face of each of the front end pieces 41a, three front end ribs 40b are erected to be arranged in the right-left direction (refer to FIG. 4). On a bottom face (back face) of the top plate 40, a pair of left and right reinforcement rib groups 43a and a pair of front and rear restraining ribs 44 are protruded.

The pair of left and right reinforcement rib groups 43 are formed in regions at both of the left and right sides of the lower face of the top plate 40 (the range excluding the center in the right-left direction). Each of the reinforcement rib groups 43 is formed in a lattice shape by ribs extending longitudinally and transversely.

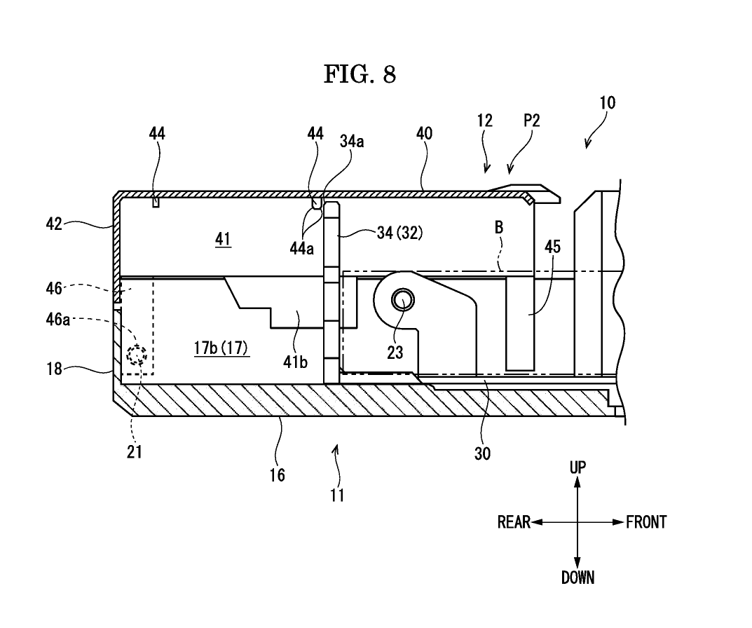

The pair of front and rear restraining ribs 44 as a restraining part are formed in a center region in the right-left direction of the lower face of the top plate 40. Each of the restraining ribs 44 is protruded toward the rear end cursor 32 (lower side) in a state in which the top face aperture 15a is closed by the cassette cover 12. Each of the restraining ribs 44 extends slightly more downward than a rib of the reinforcement rib group 43. Each of the restraining ribs 44 is extended in a linear shape in the right-left direction. Two restraining ribs 44 are arranged in parallel to each other, in the attachment direction (front-rear direction) of the cassette main body 11. At a tip end of each of the restraining ribs 44, a tapered face 44a is formed by chamfering both of the front and rear corners (refer to FIG. 8). The tapered face 44a of each of the restraining ribs 44 guides the engagement of the rear end cursor 32.

Each of the restraining ribs 44, together with each of the reinforcement rib groups 43, reinforces the cassette cover 12 (mainly, top plate 40). Thus, each of the restraining ribs 44 functions as a reinforcement member together with each of the reinforcement rib groups 43, and rigidity of the cassette cover 12 (top plate 40) can be thereby improved.

The pair of front and rear restraining ribs 44 are provided to correspond to a size of the sheet S that is housed in the cassette main body 11 (standards such as ISO 216 or JIS), in a case where the cassette main body 11 (housing 15) is covered with the cassette cover 12. As an example, in the embodiment, a front restraining rib 44 corresponds to a length in the front-rear direction of a sheet S of B4 size, and a rear restraining rib 44 corresponds to a length in the front-rear direction of a sheet of A3 size.

The pair of left and right side plates 41 each are formed in a substantially rectangular plate shapes in a side view. Each of the side plates 41 is formed at a height which is substantially equal to a step difference G between the high wall 17a and the low wall 17b (refer to FIG. 3). At a lower end of each of the side plates 41, a flange 41a extending toward the outside in the right-left direction is formed. At a substantial center in the front-rear direction of each of the side plates 41, a lateral piece 41b extending downward from the lower end is formed.

At a front end lower part of each of the side plates 41, a cover hook 45 extending to a lower side is formed. Each of the cover hooks 45 is formed so as to slacken with elasticity in the right-left direction. At a top end (lower end) of each of the cover hooks 45, a claw 45a extending toward the outside in the right-left direction is formed.

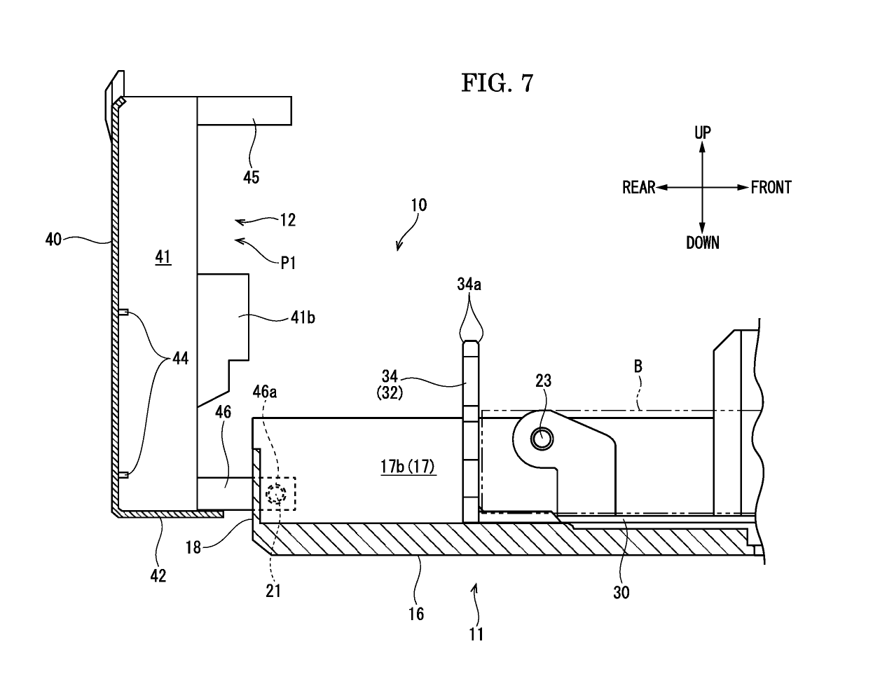

On the other hand, at a rear end lower part of each of the side plates 41, a cover supporting part 46 extending downward is formed. At a tip end (lower end) of each of the cover supporting parts 46, a shaft hole 46a is formed to penetrate in the right-left direction. In a pair of left and right shaft holes 46a, a cover turning shaft 21 formed in the housing 15 (side wall 17) is pivoted (refer to FIG. 7 or the like). Thereby, the cassette cover 12 turns about the cover turning shaft 21 (shaft hole 46a). In detail, the cassette cover 12 turns between an open position P1 to open the top face aperture 15a of the cassette main body 11 (housing 15) (refer to FIG. 3) and a closed position P2 to close the top face aperture 15a (refer to FIG. 4).

The rear plate 42 is formed in a substantially rectangular plate shape in a rear view. At a substantial center in the right-left direction of the rear plate 42, a rear end piece 42a extending downward from a lower end is formed.

Next, as shown in FIG. 2, the sheet conveying part 50 has: a pickup roller 51; a separation roller pair 52; and a conveying roller pair 53.

The pickup roller 51 is pivoted to the apparatus main body 2 at a position opposing to a top side of the front end of the lift plate 30. The pickup roller 51 rotates in the direction indicated by the arrow of FIG. 2, by a driving device (not shown).

The separation roller pair 52 oppose to each other in a vertical direction, and are arranged on the front side of the pickup roller 51. An upper roller of the separation roller pair 52 is pivoted to the mechanical retaining part 14, and a lower roller of the separation roller pair 52 is pivoted to the mechanical retaining part 14 of the cassette main body 11 (refer to FIG. 3 or the like). The separation roller pair 52 each rotate in the direction indicated by the arrow of FIG. 2, by the driving device.

The conveying roller pair 53 oppose to each other in the front-rear direction, and are arranged on an upper oblique front side of the separation roller pair 52. A rear roller of the conveying roller pair 53 is pivoted to the apparatus main body 2, and rotates in the direction indicated by the arrow of FIG. 2, by the driving device. A front roller of the conveying roller pair 53 is pivoted to the apparatus main body 2, and is pressed by the rear roller and then is driven to rotate.

Next, with reference to FIG. 3, FIG. 4, FIG. 7, and FIG. 8, the steps of setting the sheet S (sheet bundle B) to the sheet feeding cassette 10 will be described. FIG. 7 is a sectional view schematically showing a rear part of the sheet feeding cassette 10, showing a cassette cover 12 turning to an open position P1. FIG. 8 is a sectional view schematically showing a rear part of the sheet feeding cassette 10, showing a cassette cover 12 turning to a closed position P2.

Incidentally, in the following description, it is presupposed that the sheet feeding cassette 10 is pulled out from the apparatus main body 2 and then the cassette cover 12 moves to the open position P1. Also, as an example, a case of setting the sheet bundle B stacking the sheets S of B4 size will be described.

As shown in FIG. 3 and FIG. 7, a user places the sheet bundle B that is advanced into the housing 15 from the top face aperture 15a, into the lift plate 30. At this time, a front end of the sheet bundle B is abutted against the mechanical retaining part 14. Subsequently, the user slides the pair of left and right width restraining cursors 31 and the rear end cursor 32. The pair of left and right width restraining cursors 31 are displaced in the right-left direction, and abut against both of the left and right ends of the sheet bundle. The pair of left and right width restraining cursors 31 arrange both of the left and right ends of the sheets S (sheet bundle B) that are housed in the cassette main body 11. On the other hand, the rear end cursor 32 (rear end abutment part 34) is displaced in the front-rear direction, and abuts against a rear end of the sheet bundle B. The rear end cursor 32 arranges the rear end of the sheets S (sheet bundle B) that are housed in the cassette main body 11.

Next, the user turns the cassette cover 12 from the open position P1 toward the closed position P2. In the process of turning the cassette cover 12 toward the closed position P2, each of the cover hooks 45 of the cassette cover 12 abuts against a top end of each of the side walls 17 (low walls 17b) of the housing 15, and slackens to the inside against its own elastic force. When turning of the cassette cover 12 advances, each of the cover hooks 45 slides the interior face of each of the low walls 17b. When the cassette cover 12 turns to the closed position P2, the claw 45a of the cover hook 45 engages with the engaging depression 22 of the low wall 17b, and each of the cover hooks 45 reverts to its original position by its own resilient force.

As shown in FIG. 4 and FIG. 8, in a state in which the cassette cover 12 has turned to the closed position P2, each of flanges 41a of the cassette cover 12 abuts against the top of the low wall 17b of the housing 15. Also, each of the lateral pieces 41b of the cassette cover 12 abuts against the interior face of the low wall 17b, and the rear end piece 42a fits to the depression-shaped part 18a of the rear wall 18. In addition, in this state, the cassette cover 12 is disposed so as to have a height which is substantially equal to that of the high wall 17a of each of the side walls 17. Incidentally, the pair of width restraining cursors 31 are exposed to the front side of the cassette cover 12 without being covered with the cassette cover 12.

Further, as shown in FIG. 8, the front restraining rib 44 that is formed on the cassette cover 12 abuts against an upper end rear face of the rear cursor 32 (rear end abutment part 34). The rear end abutment part 34 is disposed so as to be sandwiched between the sheet bundle B and the restraining rib 44. Thus, as to the rear end cursor 32, the movement (displacement) in the front-rear direction is restrained. Incidentally, it is preferable that an overlap quantity between the restraining rib 44 and the rear end cursor 32 be 1 mm or more.

In the process of the cassette cover 12 turning toward the closed position P2, the tapered face 44a of the restraining rib 44 slides on the tapered face 34a of the rear end cursor 32. Thereby, the restraining rib 44 is capable of smoothly engaging with the rear end cursor 32 while being guided by each of the tapered face 34a, 44a. Also, for example, even in a positional relationship such that the restraining rib 44 and the rear end abutment part 34 slightly interfere with each other, the rear end abutment part 34 elastically deforms to the front side in the process of engagement with the restraining rib 44. Thereby, the restraining rib 44 and the rear end abutment part 34 (rear end cursor 32) can be smoothly engaged with each other, and damage to them is also prevented.

Next, the steps of attaching the sheet feeding cassette 10 to the apparatus main body 2 will be described. The sheet feeding cassette 10 is attached into the apparatus main body 2 in a state in which the cassette cover 12 has turned to the closed position P2.

The user inserts the sheet feeding cassette 10 (the cassette main body 11 covered with the cassette cover 12) toward the apparatus main body 2 (rearward) from the aperture 2a that is formed at the front face lower part of the apparatus main body 2 (refer to the outline arrow of FIG. 1). The user takes each of the sliding gaps 20 of the sheet feeding cassette 10 along each of the sliding rails in the apparatus main body 2 and then pushes the sheet feeding cassette 10 rearward. When pushing of the sheet feeding cassette 10 advances, the design face 13 abuts against a circumferential edge of the aperture 2a of the apparatus main body 2, and a front end of each of the sliding gaps 20 abuts against a front end of the slide rail. Thereby, as to the sheet feeding cassette 10, the movement in the attachment direction (rearward direction) is restrained (stopped) and then this cartridge is positioned in the apparatus main body 2.

Even if the movement of the sheet feeding cassette 10 stops, the sheet bundle B that is housed in the sheet feeding cassette 10 is about to continue moving backward by the inertial force. For example, in a case where the sheet feeding cassette 10 has been attached to the apparatus main body 2 with an extremer force or in a case where sheets S of a large size has been stacked as such, the inertial force acting on the sheet bundle B becomes very large. In this case, the rear end cursor 32 (rear end abutment part 34) supports the sheet bundle B on which the inertial force has acted. As described above, the rear end cursor 32 is capable of supporting the sheet bundle B that is about to move backward by the inertial force, since the rearward movement is restrained by the restraining rib 44.

Here, with reference to FIG. 2, action (sheet feeding operation) of the sheet conveying part 50 of the sheet feeding cassette 10 will be briefly described. The sheet bundle B that has been placed on the lift plate 30 is pushed up by the elevating mechanism. The pickup roller 51 abuts against a top face of the sheet bundle B, and feeds out the sheets S from the sheet bundle B toward the separation roller pair 52 one by one. The separation roller pair 52 sandwich the sheets S, and feed out them toward the conveying roller par 53. The conveying roller pair 53 sandwich the sheet S therebetween, and feed out it toward the conveying path 7 of the image forming unit 4.

Incidentally, in a case where the sheet feeding cassette 10 is detached (pulled out) from the apparatus main body 2, the user grips the operating unit (not shown) that is provided at a lower part of the design face 13 and then pulls it close to the user, and pulls out the sheet feeding cassette 10 from the apparatus main body 2. Also, although a detailed description is omitted, the user turns the cassette cover 12 from the closed position P2 to the open position P1 in accordance with the reversed steps from those described above, and can carry out replenishment or replacement or the like of the sheets S in the cassette main body 11. Incidentally, the sheet feeding cassette 10 may not be completely pulled out as long as the cassette cover 12 can be turned.

With the sheet feeding cassette 10 according to the embodiment described hereinabove, the restraining rib 44 engages with the rear end cursor 32 in the case where the top face aperture 15a has been closed by the cassette cover 12. Concurrently with the closing of the upper face 15a by the cassette cover 12, the restraining rib 44 engages with the rear end cursor 32. Thus, displacement of the sheet feeding cassette 10 along the attachment direction is restrained. Accordingly, the rear end cursor 32 is capable of supporting the sheet bundle B on which the inertial force has acted, at the time of attachment of the sheet feeding cassette 10 to the apparatus main body 2. Displacement of the sheet bundle B in the cassette main body 11 is prevented and thus a positional relationship in the attachment direction between the sheet bundle B and the pickup roller 51 (the conveyance direction of the sheet S) can be kept constant. Thereby, normal sheet feeding operation can be ensured.

Also, by removing the cassette cover 12 and opening the top face aperture 15a, the rear end cursor 32 and the restraining rib 44 are disengaged from each other. Thus, the user can smoothly displace the rear end cursor 32 in accordance with the size of the sheet S. Further, the rear end cursor 32 (rear end abutment part 34) is retained so as to be overhung between the cassette main body 11 and the cassette cover 12 (restraining rib 44). Therefore, the rear end cursor 32 is capable of effectively resisting against the inertial force acting on the sheet bundle B. Thereby, displacement of, or damage to, the rear end cursor 32, can be prevented with a simple construction without design change of the rear end cursor 32 or adding the impact buffering structure.

In addition, with the sheet feeding cassette 10 according to the embodiment, the rear end cursor 32 that is displaced (moves) in accordance with the size of the sheet S engages with the restraining rib 44 that corresponds to the size of the sheet S. Thereby, the rear end cursor 32 is capable of carrying out appropriate positional restraint according to each of the sizes of the sheets S.

Further, with the sheet feeding cassette 10 according to the embodiment, the cassette cover 12 is turnably supported on the cassette main body 11. By turning the cassette cover 12, the top face aperture 15a of the cassette main body 11 is opened or closed. Thereby, the rear end cursor 32 and the restraining rib 44 can be speedily engaged to or disengaged from each other.

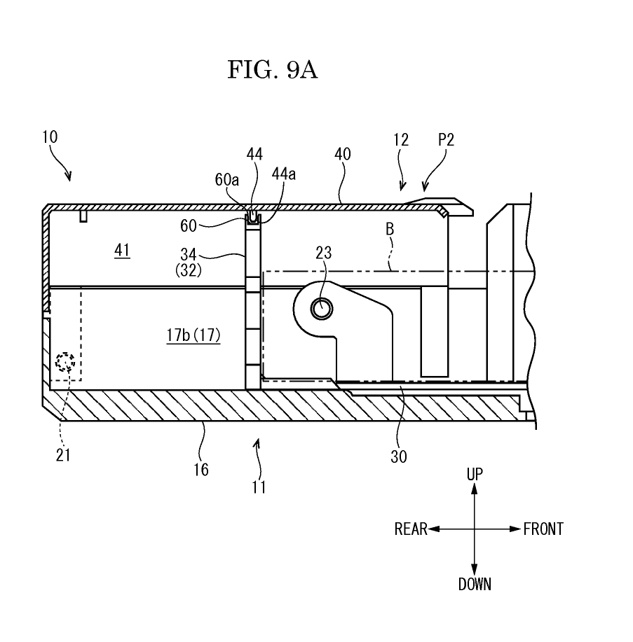

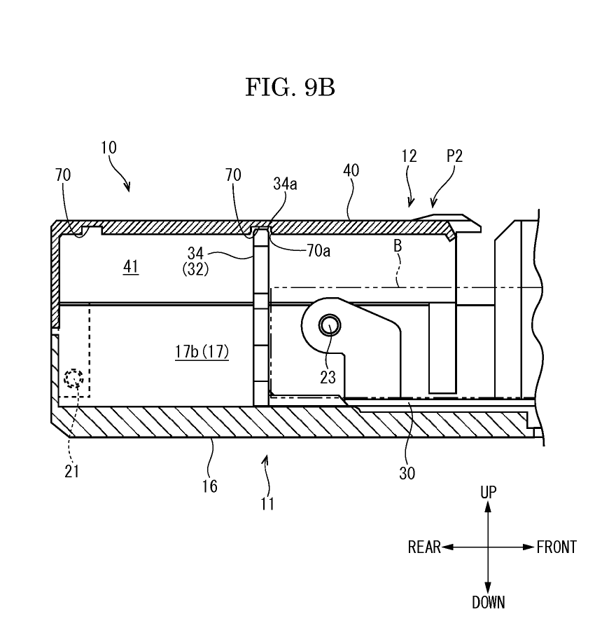

Incidentally, although the restraining rib 44 of the sheet feeding cassette 10 according to the embodiment abutted against the upper end rear face of the rear end cursor 32, the present disclosure is not limited thereto. For example, as shown in FIG. 9A, each of the restraining ribs 44 may be constructed to be inserted into a cursor depression 60 (inside tapered face 60a) which is recessed on the upper end face of the rear end cursor 32. In addition, as shown in FIG. 9B, in place of the restraining rib 44, a restraining depression 70 (inside tapered face 70a) as a restraining part may be recessed on a bottom face of the top plate 40 of the cassette cover 12. In this case, in the case where the top face aperture 15a has been closed by the cassette cover 12, the upper end of the rear end cursor 32 fits to the restraining depression 70.

Incidentally, although the restraining ribs 44 of the sheet feeding cassette 10 according to the embodiment were formed in the rib shape extending in the right-left direction, the present disclosure is not limited thereto. For example, in place of the restraining ribs 44, a pair of left and right projections to engage with only the upper end of the rear end cursor 32 may be provided as a restraining part (not shown). Also, for example, it may be that each of the restraining ribs 44 is formed at a height which is substantially equal to that of each of reinforcement rib groups 43, and the pair of left and right projections mentioned above are formed at the respective restraining ribs 44 (not shown).

Incidentally, although the sheet feeding cassette 10 according to the embodiment included the rear end cursor 32 at the cassette main body 11 and included the respective restraining ribs 44 at the cassette cover 12, the present disclosure is not limited thereto. Although not shown, it may be that the rear end cursor 32 is provided at the cassette cover 12, and the respective restraining ribs 44 are provided at the cassette main body 11.

Incidentally, although the sheet feeding cassette 10 according to the embodiment had two restraining ribs 44, the present disclosure is not limited thereto. The number of restraining ribs 44 formed is arbitrary, and one or more restraining ribs (at least one restraining rib) may be formed. In general, as the size of the sheet S increases, the weight of the sheet bundle B increases, and the inertial force also increases. Thus, it is preferable that the restraining ribs 44 be arranged in accordance with the sheet S of large size such as A3 or A4.

Incidentally, although the cassette cover 12 of the sheet feeding cassette 10 according to the embodiment was turnably supported on the cassette main body 11, the present disclosure is not limited thereto. For example, the cassette cover 12 may be formed to be mountable to or demountable from the cassette main body 11 without providing each of the cover supporting parts 46. Incidentally, the cassette cover 12 of the sheet feeding cassette 10 according to the embodiment may be provided so as to close at least apart of the top face aperture 15a. For example, the cassette cover 12 may be formed so as to close the entirety of the top face aperture 15a.

Incidentally, the sheet feeding cassette 10 according to the embodiment was attached while being pushed into the rearward direction from the front face of the apparatus main body 2 and thus the restraining ribs 44 were engagingly locked with the rear end cursor 32; and however, the present disclosure is not limited thereto. It is sufficient if the restraining rib 44 engages with the cursor that moves (is displaced) along the attachment direction of the sheet cartridge 10 (cassette main body 11) to the apparatus main body 2. For example, it is preferable that, in a case where the layout of the pair of left and right width restraining cursors 31 and the rear end cursor 32 rotates at 90 degrees on a plane, the restraining rib 44 engage with the width restraining cursor 31 that is positioned on the downstream side in the attachment direction.

Incidentally, although not shown, in a case where a sheet feeding 10 capable of housing sheets S of a large size (such as A3) is attached to an apparatus main body 2 formed to be downsized, it is preferable that a rear part of the sheet feeding cassette 10 be constructed so as to be exposed to the outside from a rear face of the apparatus main body 2. In this case, the cassette cover 12 functions as a dustproof for restraining entry of dust into the cassette main body 11 as well.

While the preferable embodiment and its modified example of the sheet feeding cassette and the image forming apparatus including this of the present disclosure have been described above and various technically preferable configurations have been illustrated, a technical range of the disclosure is not to be restricted by the description and illustration of the embodiment. Further, the components in the embodiment of the disclosure may be suitably replaced with other components, or variously combined with the other components. The claims are not restricted by the description of the embodiment of the disclosure as mentioned above.

What is claimed is:

1. A sheet feeding cassette comprising:
a cassette main body provided attachably/detachably in a casing, and configured to store sheets in a loaded state; and
a cassette cover configured to close at least a part of a top face aperture formed in the cassette main body,
wherein either one of the cassette main body and the cassette cover includes a cursor configured to be displaced along an attachment direction of the cassette main body and arrange the sheets that are housed in the cassette main body, and
another one of the cassette main body and the cassette cover includes at least one restraining part configured to engage with the cursor in a case where the top face aperture is closed by the cassette cover.

2. The sheet feeding cassette according to claim 1, wherein the at least one restraining part includes a plurality of the restraining parts, and the plurality of the restraining parts are arranged along in the attachment direction of the cassette main body, corresponding to a size of the sheets.

3. The sheet feeding cassette according to claim 1, wherein the cassette cover is turnably supported on the cassette main body.

4. The sheet feeding cassette according to claim 1,
wherein the cursor is provided at the cassette main body, and
the at least one restraining part is provided at the cassette cover, and includes a restraining rib configured to reinforce the cassette cover.

5. The sheet feeding cassette according to claim 1,
wherein the at least one restraining part is protruded toward the cursor in a state in which the top face aperture is closed by the cassette cover, and
at a tip end of the at least one restraining part, a tapered face configured to guide engagement of the cursor is formed.

6. The sheet feeding cassette according to claim 1,
wherein the cursor has:
abase configured to slidably engage with the cassette main body; and
an abutment part erected from the base toward the at least one restraining part, and abutting against an end edge of the sheets, and
at a tip end of the abutment part, a tapered face configured to guide engagement with the at least one retraining part is formed.

7. The sheet feeding cassette according to claim 1,
wherein the at least one restraining part is protruded toward the cursor in a state in which the top face aperture is closed by the cassette cover, and
the cursor has a cursor depression into which the at least one restraining part is to be inserted.

8. The sheet feeding cassette according to claim 1, wherein the at least one restraining part has a restraining depression recessed so that a tip end of the cursor engages therewith, in the state in which the top face aperture is closed by the cassette cover.

9. An image forming apparatus comprising a sheet feeding cassette provided at an apparatus main body,
the sheet feeding cassette comprising:
a cassette main body provided attachably/detachably in a casing, and configured to store sheets in a loaded state; and
a cassette cover configured to close at least a part of a top face aperture which is formed in the cassette main body,
wherein either one of the cassette main body and the cassette cover includes a cursor configured to be displaced along an attachment direction of the cassette main body and arrange the sheets that are housed in the cassette main body, and
another one of the cassette main body and the cassette cover includes at least one restraining part configured to engage with the cursor in a case where the top face aperture is closed by the cassette cover.
